(19) United States
(12) Patent Application Publication
(10) Pub. No.: US 2003/0149957 A1
(43) Pub. Date: Aug. 7, 2003

(54) Development and generation of enterprise applications using a high-level specification

(76) Inventors: Bruce K. Daniels, Capitola, CA (US); Robert N. Goldberg, Emerald Hills, CA (US); Yury Kamen, Foster City, CA (US); Syed M. Ali, Sunnyvale, CA (US)

Correspondence Address: ROSENTHAL & OSHA L.L.P. / SUN, 1221 MCKINNEY, SUITE 2800, HOUSTON, TX, 77010, US

(21) Appl. No.: 10/157,278

(22) Filed: May 29, 2002

Related U.S. Application Data
(60) Provisional application No. 60/354,771, filed on Feb. 6, 2002.

(51) Int. Cl. G06F 9/44

(52) U.S. Cl. 717/102

(57) ABSTRACT

A method for generating an enterprise application, including creating a business object specification defining a characteristic of a business object, creating an application usage specification defining how the business object is to be used in the enterprise application, and generating the enterprise application using the business object specification and the application usage specification.

### CROSS-REFERENCE TO RELATED APPLICATIONS

This application claims benefit of U.S. Provisional Application Serial No. 60/354,771 filed on Feb. 6, 2002, entitled “Development and Generation of Enterprise Applications using a High-Level Specification,” in the names of Bruce K. Daniels, Robert N. Goldberg, Yury Kamen, and Syed M. Ali.

### BACKGROUND OF INVENTION

Modern enterprise applications are typically implemented as multi-tier systems. Multi-tier systems serve the end-user through a chain of client/server pairs. In general, they include a user interface at the front end, a database management system (DBMS) at the back end, and an application server in between the user interface and the database. Depending on the component providing the user interface, an additional middle tier may exist between the user interface and the application server. For example, if the user interface is provided by a web browser, a web server would exist between the web browser and the application server. The web browser would send requests to the web server, and the web server would interact with application data in the database through the application server in order to generate a response to send to the web browser. In this scenario, the web browser and web server form a client/server pair, the web server and application server form another client/server pair, and the application server and DBMS server form another client/server pair.

FIG. 1 shows an example of a four-tiered system that includes a user interface tier (2), a web server tier (4), an application server tier (6), and a data tier (8). The user interface tier (2) is the layer of interaction and typically includes a form-like graphical user interface (GUI) displayed by a display component, typically a web browser (10). The web server tier (4) includes web components (12) hosted on a web server (14). The web components (12) generate the content displayed by the web browser (10). The application server tier (6) includes application components (16) hosted on an application server (18). The application components (16) model the business rules, typically through interaction with application data. The data tier (8) includes a persistent data store, typically a database management system (DBMS) (20) and a database (22).

The web browser (10) and the web server (14) form a client/server pair. The web server (14) and the application server (18) form another client/server pair. The application server (18) and DBMS (20) form yet another client/server pair. A web component (12) and an application component (16) are in a client/server relationship when the web component (12) (client) uses services of the application component (16) (server) to provide functions to the system. In order for the client and server to collaborate, there must be a contract, or interface definition, between the client and server that specifies the server methods that can be invoked by the client. When the client and server are in different address spaces, the client uses some form of remote procedure call (RPC) to invoke the server methods. Typically, this involves the client calling into a local stub, which forwards the call to the server.

Multi-tiered enterprise applications, such as described above, are difficult to write because they are inherently complex. The enterprise application developers are expected to be well-versed in many subject areas. The enterprise application developers are expected to be able to understand the business problem and logic to solve the problem, group business logic into transactions, understand how to retrieve and update information in the database, and know how to use multi-processing capabilities to enhance performance of the enterprise application. The enterprise application developers must also take into account the type of clients to be supported and the communication protocol to be used between the client and server, the type of server and the enterprise application program interfaces (APIs) supported by the server, and the type of database management system (DBMS) used in managing the database.

### SUMMARY OF INVENTION

In general, in one aspect, the invention relates to a method for generating an enterprise application, comprising creating a business object specification defining a characteristic of a business object, creating an application usage specification defining how the business object is to be used in the enterprise application, and generating the enterprise application using the business object specification and the application usage specification.

In general, in one aspect, the invention relates to a method for generating an enterprise application, comprising creating a business object specification defining a characteristic of a business object, creating an application usage specification defining how the business object is to be used in the enterprise application, generating the enterprise application using the business object specification and the application usage specification to execute on a first platform, and re-generating the enterprise application to execute on a second platform.

In general, in one aspect, the invention relates to a computer-readable medium having recorded thereon instructions executable by a processor, the instructions for receiving a business object specification defining a characteristic of a business object, receiving an application usage specification defining how the business object is to be used in the enterprise application, and generating the enterprise application using the business object specification and the application usage specification.

In general, in one aspect, the invention relates to an apparatus for generating an enterprise application, comprising means for creating a business object specification defining a characteristic of a business object, means for creating an application usage specification defining how the business object is to be used in the enterprise application, and means for generating the enterprise application using the business object specification and the application usage specification.

In general, in one aspect, the invention relates to an apparatus for generating an enterprise application, comprising means for creating a business object specification defining a characteristic of a business object, means for creating an application usage specification defining how the business object is to be used in the enterprise application, means for generating the enterprise application using the business object specification and the application usage specification to execute on a first platform, and means for regenerating the enterprise application to execute on a second platform.

Other aspects and advantages of the invention will be apparent from the following description and the appended claims.

### BRIEF DESCRIPTION OF DRAWINGS

FIG. 1 illustrates a typical multi-tier system.

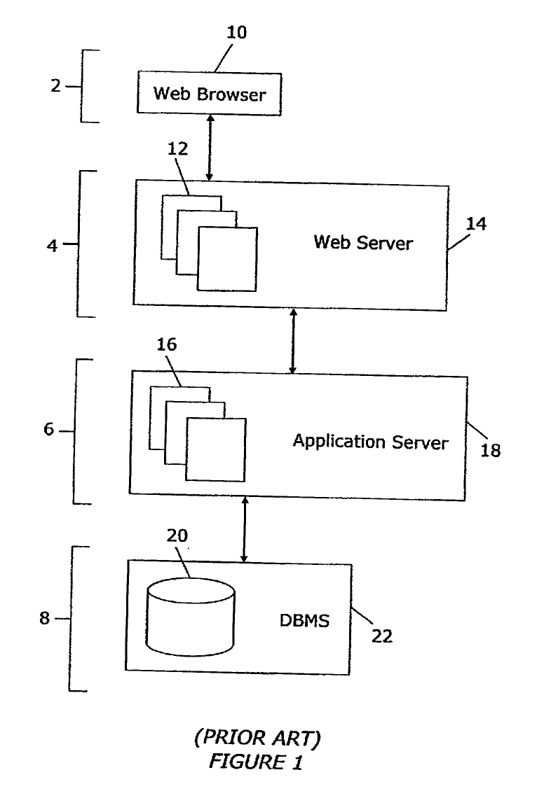

FIG. 2 illustrates a typical computer.

FIG. 3 illustrates a flow diagram for development and generation of an enterprise application in accordance with one embodiment of the invention.

FIG. 4 illustrates a graphical representation of a business object specification in accordance with one embodiment of the invention.

FIG. 5 illustrates a graphical representation of an application usage specification in accordance with one embodiment of the invention.

### DETAILED DESCRIPTION

Exemplary embodiments of the invention will be described with reference to the accompanying drawings. Like items in the drawings are shown with the same reference numbers.

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

The invention relates to a method for developing and generating an enterprise application. Further, the invention relates to using a business object specification and an application usage specification to develop and generate the enterprise application. Further, the invention relates to re-generating an enterprise application for a plurality of platforms.

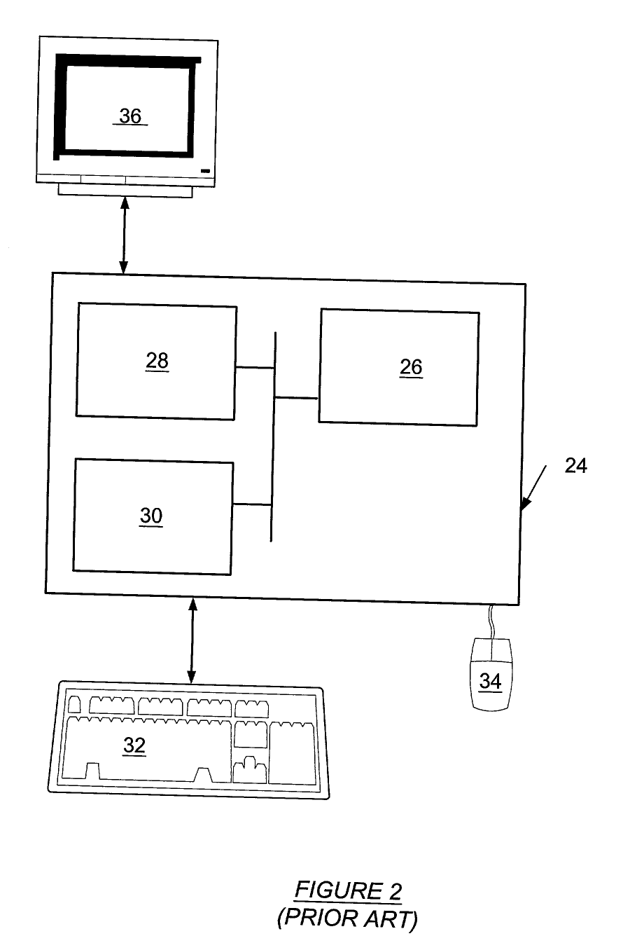

The present invention may be implemented on virtually any type computer regardless of the platform being used. For example, as shown in FIG. 2, a typical computer (24) includes a processor (26), associated memory (28), a storage device (30), and numerous other elements and functionalities typical of today's computers (not shown). The computer (24) may also include input means, such as a keyboard (32) and a mouse (34), and output means, such as a monitor (36). Those skilled in the art will appreciate that these input and output means may take other forms in an accessible environment.

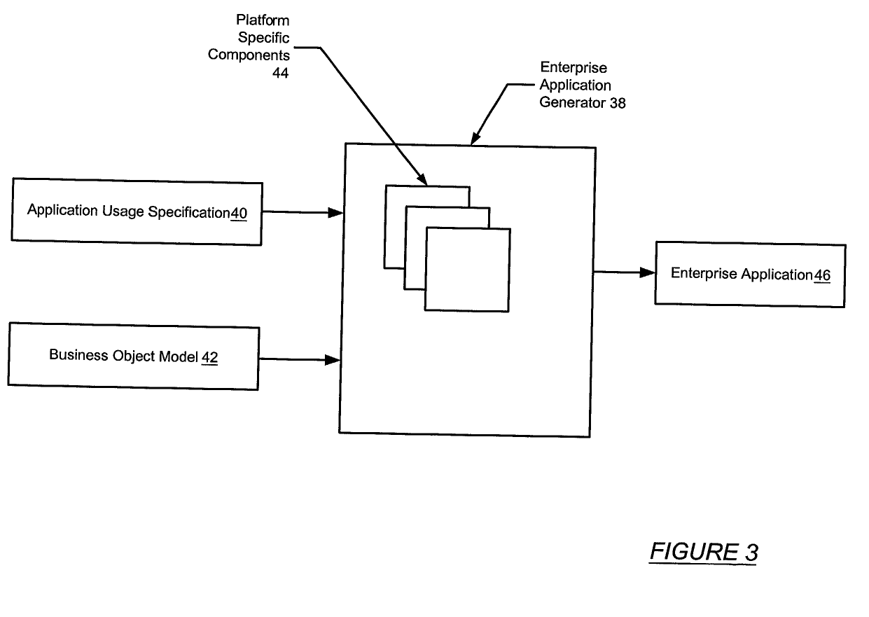

FIGS. 3 illustrates a flow diagram for development and generation of an enterprise application in accordance with one embodiment of the invention. The enterprise application generator (EAG) (38) takes a business object specification (BOS) (42) and an application usage specification (AUS) (40) as inputs and generates an enterprise application (EA) (46).

The BOS (42) defines the characteristics of all business objects to be used in the EA (46). These characteristics may include, but are not limited to, attributes, attribute constraints, persistence information, triggers, relationships, business object methods, etc. For example, the BOS (42) may define a trigger for a particular business object such that when a specific event occurs, such as an update to a data field in a database, a set of Structured Query Language (SQL) statements is “fired-off” to perform an integrity check on the database. Additionally, in accordance with one embodiment of the invention, the business object methods define enterprise application and process logic. Further, the BOS (42) defines the relationships between the various business objects.

The following code illustrates an exemplary business object specification, in accordance with the embodiment described above.

Code Sample 1: Business Object Specification

| | |
|---|---|
| 1 | persistent class PurchaseOrder { |

| | |
|---|---|
| 2 | PROPERTIES { UUID = “ID_C0048140360711D6B3B30080C74455C6” }; |
| 3 | persistent Long orderId; |
| 4 | persistent Date orderDate = new Date(0); |
| 5 | persistent String shipToName; |
| 6 | persistent String shipToPhone; |
| 7 | persistent String shipToAddress1; |
| 8 | persistent String shipToAddress2; |
| 9 | persistent String shipToCity; |
| 10 | persistent String shipToState; |
| 11 | persistent String shipToZip; |
| 12 | persistent String shipToCountry = “USA”; |
| 13 | persistent String billToName; |
| 14 | persistent String billToPhone; |
| 15 | persistent String billToAddressl; |
| 16 | persistent String billToAddress2; |
| 17 | persistent String billToCity; |
| 18 | persistent String billToState; |
| 19 | persistent String billToZip; |
| 20 | persistent String billToCountry = “USA”; |
| 21 | computed Decimal orderTotal = |

| | |
|---|---|
| 22 | { |

| | |
|---|---|
| 23 | BigDecimal total = new BigDecimal(0); |
| 24 | Iterator i = getLineItems( ).iterator( ); |
| 25 | while(i.hasNext( )) { |

| | |
|---|---|
| 26 | LineItem li = (LineItem )i.next( ); |
| 27 | total = total.add(li.getLineTotal ( ); |

| | |
|---|---|
| 28 | } |
| 29 | return total; |

| | |
|---|---|
| 30 | } owns (0,n,1,1) LineItem lineItems orderId; |
| 31 | |

| | |
|---|---|
| 32 | PRIMARY KEY (orderId); |
| 33 | |
| 34 | factory method myOrders (String billToName) returns List of |

| | |
|---|---|
| 35 | PurchaseOrder |
| 36 | |
| 37 | QUERY ( SELECT p |

| | |
|---|---|
| 38 | FROM PurchaseOrder p |
| 39 | WHERE billToName = :billToName |
| 40 | |

| | |
|---|---|
| 41 | factory method nextId( ) returns Long |
| 42 | |

| | |
|---|---|
| 43 | QUERY ( SELECT MAX(p.orderId) + 1 |

| | |
|---|---|
| 44 | FROM PurchaseOrder p |
| 45 | |
| 46 | |

| | |
|---|---|
| 47 | factory method assignNextPK( ) returns PurchaseOrderPK |
| 49 | |

| | |
|---|---|
| 49 | { |

| | |
|---|---|
| 50 | synchronized (this.getClass( )) { |

| | |
|---|---|
| 51 | PurchaseOrderFactory f = (PurchaseOrderFactory |

| | |
|---|---|
| 52 | )Global.factoryManager( ) .getFactory(PurchaseOrder .class); |

| | |
|---|---|
| 53 | PurchaseOrderPK pk; |
| 54 | pk = f.newPrimaryKey(nextId( ) .longValue ( )); |
| 55 | return pk; |

| | |
|---|---|
| 56 | } |

| | |
|---|---|
| 57 | } |
| 58 | |

| | |
|---|---|
| 59 | } // class PurchaseOrder |
| 60 | |
| 61 | persistent class LineItem { |
| 62 | |

| | |
|---|---|
| 63 | PROPERTIES { UUID = “ID_C00A9BC0360711D6B3B30080C74455C6” }; |
| 64 | |
| 65 | persistent Long orderLine; |
| 66 | persistent String productId; |
| 67 | persistent String productName; |
| 68 | persistent String productDescription; |
| 69 | persistent Decimal unitPrice; |
| 70 | persistent Long quantity; |
| 71 | computed Decimal lineTotal = ((this.getUnitPrice( ) .multiply( |

| | |
|---|---|
| 72 | new BigDecimal (String.valueOf (this.getQuantity( )))))); |
| 73 | |

| | |
|---|---|
| 74 | PRIMARY KEY (orderId, orderLine); |
| 75 | |
| 76 | |
| 77 | factory method nextLineNumber (Long orderId) returns Long |
| 78 | |

| | |
|---|---|
| 79 | QUERY ( SELECT MAX(li.orderLine) + 1 |

| | |
|---|---|
| 80 | FROM LineItem li |
| 81 | WHERE li.orderId = :orderId |
| 82 | |
| 83 | |

| | |
|---|---|
| 84 | factory method assignNextPK(PurchaseOrder master) returns LineItemPK |
| 85 | |

| | |
|---|---|
| 86 | { |

| | |
|---|---|
| 87 | synchronized (this.getClass ( )) { |

| | |
|---|---|
| 88 | LineItemFactory f = (LineItemFactory |

| | |
|---|---|
| 89 | )Global.factoryManager( ) .getFactory(LineItem .class); |

| | |
|---|---|
| 90 | LineItemPK pk = f.newPrimaryKey(master, |

| | |
|---|---|
| 91 | f.nextLineNumber(master.getorderId( )) .longValue ( )); |

| | |
|---|---|
| 92 | return pk; |

| | |
|---|---|
| 93 | } |

| | |
|---|---|
| 94 | } |
| 95 | |

| | |
|---|---|
| 96 | } // class LineItem |

In the code sample listed above, referred to as “Code Sample 1”, lines 1-59 define a PurchaseOrder business object. Specifically, within the PurchaseOrder business object, lines 3-29 define attributes of the PurchaseOrder business object. Line 30 defines a relationship between the PurchaseOrder business object and a LineItem business object; in particular, the PurchaseOrder business object “own” the LineItem business object. Line 32 defines the primary key of the PurchaseOrder business object. Lines 34-59 define methods for the PurchaseOrder object. Lines 61-96 define the LineItem business object.

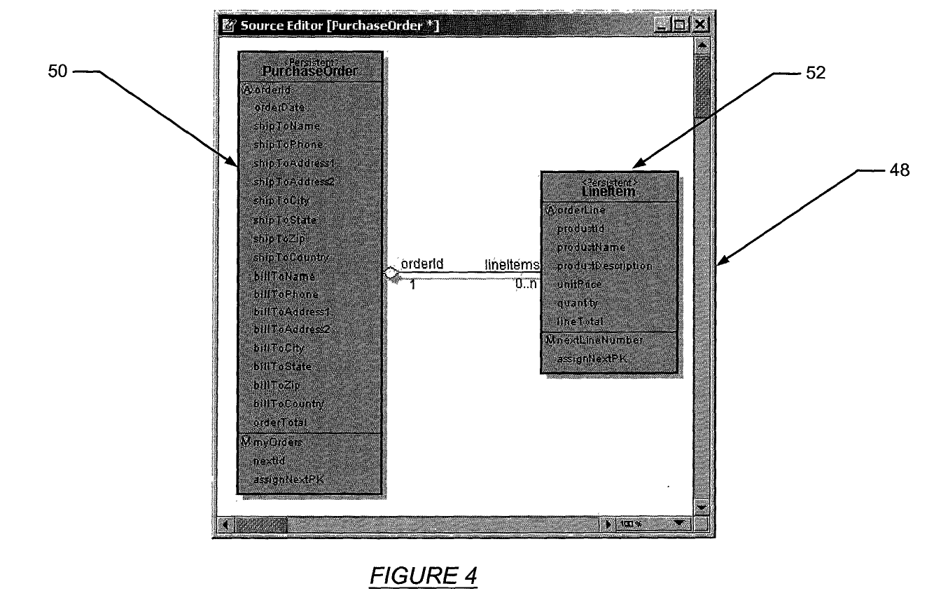

FIG. 4 illustrates a graphical representation of a business object specification in accordance with one or more embodiments of the invention. The graphical representation of the BOS (48) corresponds to “Code sample 1” listed above. The BOS (48) includes two business objects: PurchaseOrder (50), and LineItem (52). Further, the BOS (48) graphically illustrates the “own” relationship. In addition, each business object (PurchaseOrder (50) and LineItem (52)) within the BOS (48) include all attributes and methods defined in “Code Sample 1.”

In one embodiment of the invention, an integrated development environment (IDE) is used to graphically define the business object specification. In one embodiment of the invention, the IDE is Forte™ for Java™.

Returning to FIG. 3, the AUS (40) defines how the business objects, as defined by the BOS (42), are to be used within the enterprise application. In one or more embodiments of the invention, the AUS (40) is defined as a series of states and transitions. A state defines an interaction with a client (i.e., a user, another enterprise application, a web service, etc.). The interaction may include, but is not limited to, a user gesture (e.g., a button click, voice commands, etc.), an interaction from another enterprise application (e.g., via a web service using Simple Object Access Protocol (SOAP)), etc. Those skilled in the art will appreciate that an interaction may take on other forms in an accessible environment.

In a web-based application, for example, a user may be presented with a screen that requires them to enter a number corresponding to the number of items they wish to purchase and then click the “proceed” button. In this case, that particular web page would represent the state. Further, a state may contain an embedded state. The embedded state corresponds to a state residing in a state. For example, in a web page, a state may correspond to the entire web page and the embedded state may correspond to a frame within the web page. Additionally, a state may also contain a conditional state. For example, a conditional state may display the current date and time to the user, thus, the state is conditional on the current time and date.

The transitions correspond to business logic of the enterprise application. Continuing with the web page example above, when the user clicks the “proceed” button, the transition is initiated. In this particular case, the transition may include code to determine the total price of the products being ordered using the number of items the user previously entered.

The transitions are used to link the various states together forming an overall business process. Further, a particular enterprise application may be defined such that numerous transitions may be used to exit a particular state. For example, in a web-based application, a particular screen may have a “proceed” button and an “exit” button, where each button triggers a different set of business logic. Further, numerous transitions may also be used to enter a particular state. For example, a “proceed” button on one page and a “cancel” button on another page could both result in bringing the user back to an enterprise applications homepage.

Additionally, the AUS (40) may also define interaction variables. The interaction variable defines a piece of data which is going to interact with the user, or to facilitate interactions within the enterprise application or with the end user, e.g., parameters passed between states, shared variables, session variables, state variables, etc.

The following code illustrates an exemplary application usage specification, in accordance with the embodiment described above.

Code Sample 2: Application Usage Specification

| | |
|---|---|
| 1 | package com.sun.purchaseorder; |
| 2 | |
| 3 | bos POApplication = com.sun.purchaseorder; |
| 4 | |
| 5 | session String customerName; |
| 6 | |
| 7 | initial state { |
| 8 | |

| | |
|---|---|
| 9 | { customerName = “”; |
| 10 | } |
| 11 | |
| 12 | customerName: C ; |
| 13 | |
| 14 | transition Start { |

| | |
|---|---|
| 15 | switch (customerName) { |

| | |
|---|---|
| 16 | case “”: return new initial( )); |
| 17 | default: return new ChoosePO( ); |

| | |
|---|---|
| 18 | } |
| 19 | |

| | |
|---|---|
| 20 | } // transition Start |
| 21 | |

| | |
|---|---|
| 22 | } // state initial |
| 23 | |
| 24 | state ChoosePO( ) |
| 25 | { |

| | |
|---|---|
| 26 | local List of PurchaseOrder purchaseOrders; |
| 27 | |
| 28 | { purchaseOrders = |

| | |
|---|---|
| 29 | factory (POApplication.PurchaseOrder) .myOrders (customerName); |

| | |
|---|---|
| 30 | } |
| 31 | |
| 32 | [purchaseOrders(0,n)]: R { |

| | |
|---|---|
| 33 | orderId “Order ID” |

| | |
|---|---|
| 34 | } |
| 35 | |
| 36 | transition CreatePO “Create Purchase Order” { |

| | |
|---|---|
| 37 | return new CreatePO( ); |
| 38 | |

| | |
|---|---|
| 39 | } // transition CreatePO |
| 40 | |
| 41 | transition DeletePO “Delete Purchase Order” { |

| | |
|---|---|
| 42 | PurchaseOrder po = purchaseOrders.getSelectedOne( ); |
| 43 | factory(POApplication.PurchaseOrder) .remove(po); |
| 44 | return new ChoosePO( ); |
| 45 | |

| | |
|---|---|
| 46 | } // transition DeletePO |
| 47 | |
| 48 | transition EditPO “Edit Purchase Order” { |

| | |
|---|---|
| 49 | PurchaseOrder po = purchaseOrders.getSelectedOne( ); |
| 50 | return new EditPO(po); |
| 51 | |

| | |
|---|---|
| 52 | } // transition EditPO |
| 53 | |

| | |
|---|---|
| 54 | } // state ChoosePO |
| 55 | |
| 56 | state CreatePO( ) |
| 57 | { |
| 58 | |
| 59 | |
| 60 | # =“ This state transfers directly to EditPO since it has no usage and one |
| 61 | transition ” |

| | |
|---|---|
| 62 | transition CreateAndEditPO { |

| | |
|---|---|
| 63 | PurchaseOrderPK pk = |

| | |
|---|---|
| 64 | factory (POApplication.PurchaseOrder) .assignNextPK( ); |

| | |
|---|---|
| 65 | PurchaseOrder po = factory(POApplication.PurchaseOrder) .create(pk); |
| 66 | po.setBillToName(customerName); |
| 67 | return new EditPO (po); |
| 68 | |

| | |
|---|---|
| 69 | } // transition CreateAndEditPO |
| 70 | |

| | |
|---|---|
| 71 | } state CreatePO |
| 72 | |
| 73 | state EditPO( PurchaseOrder po) “Edit Purchase Order” |
| 74 | { |
| 75 | |

| | |
|---|---|
| 76 | po: RW |

| | |
|---|---|
| 77 | orderId “Order ID”: R , |
| 78 | orderDate “Date”, |
| 79 | shipToName “Ship To”, |
| 80 | shipToPhone “Phone”, |
| 81 | shipToAddress1 “Address”, |
| 82 | shipToAddress2 “Address2”, |
| 83 | shipToCity “City”, |
| 84 | shipToState “State”, |
| 85 | shipToZip “Zip Code”, |
| 86 | shipToCountry “Country”, |
| 87 | billToName “Bill To”, |
| 88 | billToPhone “Phone”, |
| 89 | billToAddress1 “Address”, |
| 90 | billToAddress2 “Address2”, |
| 91 | billToCity “City”, |
| 92 | billToState “State”, |
| 93 | billToZip “Zip Code”, |
| 94 | billToCountry “Country”, |
| 95 | [lineItems(0,n)] “Line Items” { |

| | |
|---|---|
| 96 | orderLine “Item”, |
| 97 | productId “Product ID”, |
| 98 | productName “Product”, |
| 99 | productDescription “Description”, |
| 100 | unitPrice “Unit Price”, |
| 101 | quantity “Quantity” |

| | |
|---|---|
| 102 | } |

| | |
|---|---|
| 103 | } |
| 104 | |
| 105 | transition Update { |

| | |
|---|---|
| 106 | return new EditPO(po); |
| 107 | |

| | |
|---|---|
| 108 | } // transition Update |
| 109 | |
| 110 | transition AddLineItem “Add Line Item” { |

| | |
|---|---|
| 111 | LineItemPK pk = factory(POApplication.LineItem) .assignNextPK(po); |
| 112 | LineItem li = factory(POApplication.LineItem).create(pk); |
| 113 | return new EditPO(po); |
| 114 | |

| | |
|---|---|
| 115 | } // transition AddLineItem |
| 116 | |
| 117 | transition DeleteLineltem “Delete Line Item” { |

| | |
|---|---|
| 118 | LineItem li = po.lineItems.getSelectedOne( ); |
| 119 | factory(PoApplication.LineItem) .remove(li); |
| 120 | return new EditPO(po); |
| 121 | |

| | |
|---|---|
| 122 | } // transition DeleteLineItem |
| 123 | |
| 124 | transition Done “Done Editing Purchase Order” { |

| | |
|---|---|
| 125 | return new ChoosePO( ); |
| 126 | |

| | |
|---|---|
| 127 | } // transition Done |
| 128 | |
| 129 | transition Discard “Discard Edits” { |

| | |
|---|---|
| 130 | return new DiscardEdits( ); |
| 131 | |

| | |
|---|---|
| 132 | } transition Discard |
| 133 | |

| | |
|---|---|
| 134 | } state EditPO |
| 135 | |
| 136 | state DiscardEdits( ) |
| 137 | { |

| | |
|---|---|
| 138 | local String message; |
| 139 | |
| 140 | { message = “Edits discarded”; |
| 141 | } |
| 142 | |
| 143 | message: R ; |
| 144 | |
| 145 | transition Continue { |

| | |
|---|---|
| 146 | return new ChoosePO( ); |
| 147 | |

| | |
|---|---|
| 148 | } // transition Continue |
| 149 | |

| | |
|---|---|
| 150 | } // state DiscardEdits |

In the code sample listed above referred to as “Code Sample 2”, each state with the corresponding transitions are defined. Lines 7-22 define the Initial State and the necessary information for the Start transition. Similarly, lines 24-54 define the ChoosePO state and corresponding transitions, lines 56-74 define the CreatePO state and corresponding transition, lines 73-134 define the EditPO State and corresponding transitions, and lines 136-150 define the DiscardEdits State and corresponding transitions.

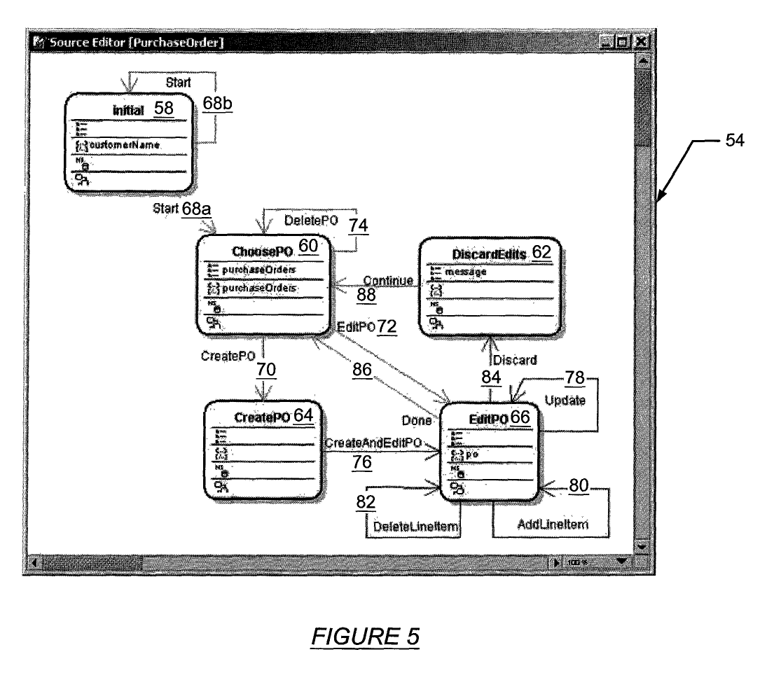

FIG. 5 illustrates a graphical representation of an application usage specification in accordance with one or more embodiments of the invention. The graphical representation of the AUS (54) corresponds to “Code Sample 2” listed above. The AUS (54) uses the BOS (48) described above. The AUS (54) includes five states: Initial (58), ChoosePO (60), DiscardEdits (62), CreatePO (64), and EditPO (66). Linking each state is a series of transitions.

For example, the Initial (58) state includes one transition: Start (68a, 68b). The Start (68a, 68b) transition branches depending on conditions specified in the code (refer to lines 14-17 in Code Sample 2). Thus, the Start (68a, 68b) transition may transition the enterprise application to the ChoosePO (60) state via 68a, or return the enterprise application to the Initial (58) state via 68b. From the ChoosePO (60) state, the enterprise application can transition to the CreatePO (64) state via the CreatePO (70) transition; the enterprise application can transition to the EditPO (66) state via the EditPO (72) transition; or transition back to ChoosePO (60) state via the DeletePO (74) transition. From the CreatePO (64) state, the enterprise application can transition to the EditPO (66) state via a CreateAndEditPO (76) transition.

The EditPO (66) state includes five transitions. The Update (78) transition, the AddLineltem (80) transition, and the DeleteLineltem (82) transition all return the enterprise application back to the EditPO (66) state. The Discard (84) transition places the enterprise application in the DiscardEdits (62) state. The Done (86) transition places the enterprise application in the ChoosePO (60) state. From the DiscardEdit (62) state the enterprise application can transition to the ChoosePO (60) state via the Continue (88) transition.

In one embodiment of the invention, an integrated development environment (IDE) is used to graphically define the application usage specification. In one embodiment of the invention, the IDE is Forte™ for Java™.

Referring back to FIG. 3, the EAG (38) includes a number of code generation components (CGC) (44). The CGC (44) correspond to generator components designed specifically for a particular platform. For example, if an enterprise application is deployed on an Apache Web Server, an iPlanet™ Application server, and Oracle® Database Management System, the EAG (38) will contain CGC (44) corresponding to the Apache Web Server, the iPlanet™ Application server, and the Oracle® Database Management System. (iPlanet™ is a trademark of Sun Microsystems, and Oracle® is a registered trademark of the Oracle Corporation).

Further, the CGC (44) encapsulates best-mode practices to produce optimized efficient code for the various components in the enterprise application (46). For example, the EAG (38) includes functionality to increase performance efficiency of the generated enterprise application by optimizing enterprise application implementation code. This optimization may include, but is not limited to, the use and generation of optimal distribution protocols to ensure maximal network access and response time within a given platform for high enterprise application performance and scalability, optimization for lock contention, optimization for memory usage, optimization for processor usage, optimization for code readability, etc.

In the event that a particular component within the enterprise application (46) changed, the enterprise application (46) may be re-generated using the same AUS (40) and BOS (42) provided that the appropriate CGC (44) are present in the EAG (38).

Further, in one or more embodiments of the invention the EAG (38) also includes functionality to determine the most efficient platform for deployment based on the AUS (40) and BOS (42) input into the EAG (38).

The invention has one or more of the following advantages. The invention uses a platform independent specification i.e., application usage specification and business object specification, to describe an enterprise application thereby decreasing the knowledge barrier of a programmer to create an enterprise application and decreasing time to develop prototypes to facilities feed-back. Further, using a platform independent specification allows an enterprise application to be easily migrated to existing platforms, and platforms yet to be developed. Further, the invention increases the performance efficiency for the enterprise application by generation of optimal distribution protocols. Furtherm the invention produces a concise code specification allowing rapid enterprise application development. Additionally, the intuitive nature of the code specification allows people other than programmers to participate in the application development process. Additionally, the invention increases the robustness of the enterprise application as a majority of code generated by the code generator.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for generating an enterprise application, comprising:
creating a business object specification defining a characteristic of a business object;
creating an application usage specification defining how the business object is to be used in the enterprise application; and
generating the enterprise application using the business object specification and the application usage specification.

2. The method of claim 1, further comprising:
re-generating the enterprise application to execute on a plurality of platforms.

3. The method of claim 1, the business object specification comprising a relationship for the business object.

4. The method of claim 1, the business object specification comprising a constraint for the business object.

5. The method of claim 1, the business object specification comprising a trigger for the business object.

6. The method of claim 1, the business object specification comprising a business object method.

7. The method of claim 1, the application usage specification comprising a state and a transition.

8. The method of claim 7, the state comprising an embedded state.

9. The method of claim 7, the state comprising a conditionally embedded state.

10. The method of claim 7, wherein the state defines an interaction with a client.

11. The method of claim 1, wherein the application usage specification defines an interaction variable.

12. The method of claim 11, wherein the interaction variable corresponds to the characteristic of the business object in the business object specification.

13. The method of claim 7, the transition comprising business logic of the application.

14. The method of claim 7, wherein the transition is used to exit the state.

15. The method of claim 7, wherein the transition is used to enter the state.

16. The method of claim 1, wherein the business object specification is created using a graphical user interface.

17. The method of claim 1, wherein the application usage specification is created using a graphical user interface.

18. The method of claim 1, generating the enterprise application comprises a code generator.

19. The method of claim 18, wherein the code generator comprising a plurality of code generation components specific to a plurality of platform components.

20. The method of claim 18, wherein the code generator optimizes the enterprise application for use in a distributed environment.

21. The method of claim 1, wherein the application usage specification is platform independent.

22. The method of claim 1, wherein the business object specification is platform independent.

23. The method of claim 1, the application usage specification comprising a transaction.

24. A method for generating an enterprise application, comprising:
creating a business object specification defining a characteristic of a business object;
creating an application usage specification defining how the business object is to be used in the enterprise application;
generating the enterprise application using the business object specification and the application usage specification to execute on a first platform; and
re-generating the enterprise application to execute on a second platform.

25. A computer-readable medium having recorded thereon instructions executable by a processor, the instructions for:
receiving a business object specification defining a characteristic of a business object;
receiving an application usage specification defining how the business object is to be used in the enterprise application; and
generating the enterprise application using the business object specification and the application usage specification.

26. An apparatus for generating an enterprise application, comprising:
means for creating a business object specification defining a characteristic of a business object;
means for creating an application usage specification defining how the business object is to be used in the enterprise application; and
means for generating the enterprise application using the business object specification and the application usage specification.

27 An apparatus for generating an enterprise application, comprising:
means for creating a business object specification defining a characteristic of a business object;
means for creating an application usage specification defining how the business object is to be used in the enterprise application;
means for generating the enterprise application using the business object specification and the application usage specification to execute on a first platform; and
means for regenerating the enterprise application to execute on a second platform.
